(19) United States
(12) Patent Application Publication
(10) Pub. No.: US 2026/0268660 A1
(43) Pub. Date: Sep. 10, 2026

(54) GROWTH STATE ESTIMATION APPARATUS, PLANT MANAGEMENT SYSTEM, GROWTH STATE ESTIMATION METHOD, PLANT MANAGEMENT METHOD, AND NON-TRANSITORY COMPUTER READABLE MEDIUM

(71) Applicant: Yokogawa Electric Corporation, Tokyo (JP)

(72) Inventors: Emiko HATSUGAI, Tokyo (JP); Junshan WANG, Tokyo (JP); Hirari SATOU, Tokyo (JP)

(21) Appl. No.: 19/166,042

(22) PCT Filed: Mar. 6, 2024
(86) PCT No.: PCT/JP2024/008465

§ 371 Date: Sep. 17, 2025

(30) Foreign Application Priority Data
Mar. 23, 2023 (JP) 2023-047369

(51) Int. Cl. G06V 20/10; A01G 9/18; A01G 9/24; G06V 10/74

(52) U.S. Cl. CPC G06V 20/188; A01G 9/18; A01G 9/249; G06V 10/74

(57) ABSTRACT

A growth state estimation apparatus may include an acquisition unit which acquires a first image including a plant captured at a first time point and a second image including the plant captured at a second time point after the first time point. The growth state estimation apparatus may include a specifying unit which specifies a same specific part of the plant from each of the first image and the second image. The growth state estimation apparatus may include an estimation unit which estimates a growth state of the plant by comparing a state of the same specific part included in each of the first image and the second image.

### TECHNICAL FIELD

The contents of the following patent application(s) are incorporated herein by reference: NO. 2023-047369 filed in JP on Mar. 23, 2023

The present invention relates to a growth state estimation apparatus, a plant management system, a growth state estimation method, a plant management method, and a program.

### BACKGROUND

Patent Document 1 describes that a scan using a pulsed distance measuring light with two wavelengths having different reflectances relative to nitrogen contents is performed with a laser scanner 4; the two wavelengths are separated and the separated lights are received; a distance measurement value and an amount of light are detected for each pulsed distance measuring light and for each of the two wavelengths; height of a crop is detected based on the distance measurement value; a received light amount ratio for the two wavelengths is detected; and growth states of the crop are detected based on the detected height and the received light amount ratio.

### RELATED ART DOCUMENTS

### Patent Documents

Patent document 1: Japanese Patent Application Publication No. 2022-54395

### GENERAL DISCLOSURE

### Technical Problem

It is desirable to reduce a burden of processing to estimate a growth state of a plant.

### Solution to Problem

A growth state estimation apparatus according to one aspect of the present invention may include an acquisition unit which acquires a first image including a plant captured at a first time point and a second image including the plant captured at a second time point after the first time point. The growth state estimation apparatus may include a specifying unit which specifies a same specific part of the plant from each of the first image and the second image. The growth state estimation apparatus may include an estimation unit which estimates a growth state of the plant by comparing a state of the same specific part included in each of the first image and the second image. The specific part of the plant may be a leaf, a stem, a fruit, or a flower.

The growth state estimation apparatus may further include a prediction unit which predicts a change, which is a change with passage of time from the first time point to the second time point, in a growth state of the same specific part, based on change information indicating a change in a growth state of a specific part in accordance with passage of time of the specific part.

The specifying unit may specify the same specific part from each of the first image and the second image, further based on a prediction result of the prediction unit. The prediction unit may specify a growth period of the plant at the first time point from an area of the specific part at the first time point, based on the change information. The prediction unit may predict predicts an area of the specific part of the plant when time has passed from the first time point to the second time point, based on the change information. The specifying unit may specify the same specific part from each of the first image and the second image, based on a prediction result of the prediction unit. The specifying unit may specify, from the second image, the same specific part as the specific part included in the first image by enlarging an area of the specific part in the first image to be an area based on the prediction result and performing pattern matching between the first image in which the specific part is enlarged and an image including at least one specific part in a predetermined region of the second image. The predetermined region may be a region in the second image corresponding to a region including the specific part of the first image and having a predetermined size. Alternatively, the specifying unit may derive, in the second image, an area of at least one specific part included in a predetermined region including a position where the specific part of the first image exists, and specify, from among the at least one specific part, a specific part having the predicted area of the specific part at the second time point, so as to specify the same specific part.

In any of the growth state estimation apparatuses, the estimation unit may estimate, as the growth state of the plant, a state of a physiological disorder of the plant or impairment caused by diseases and pests. The estimation unit may estimate a type of a physiological disorder of a specific part occurring in the plant by pattern matching an image for each type of a physiological disorder of a predetermined specific part with an image of the same specific part included in the first image and the second image.

In any of the growth state estimation apparatuses, the estimation unit may compare a state of the same specific part included in each of the first image and the second image, so as to specify a transition in a size of the same specific part and a transition in a size of an impaired part of the same specific part, and estimate, as the growth state of the plant, a progression degree of impairment of the same specific part, based on comparison of the transition in the size of the same specific part and the transition in the size of the impaired part of the same specific part.

In any of the growth state estimation apparatuses, the estimation unit may estimate, as the growth state of the plant, the progression degree of the impairment of the same specific part, based on a ratio of an increase rate in the size of the same specific part to an increase rate in the size of the impaired part of the same specific part from the first time point to the second time point.

The plant management system according to one aspect of the present invention may include: the growth state estimation apparatus; and an environmental control unit which controls environmental control equipment which controls environment in a plant factory where the plant is cultivated, according to a predetermined condition corresponding to an estimation result of the growth state of the plant by the estimation unit. The plant management system may further include an imaging apparatus which images the plant. The imaging apparatus may periodically image the plant at predetermined intervals in a same direction and at a same angle of view from a same position. The acquisition unit may acquire the first image and the second image from the imaging apparatus.

In the plant management system, the predetermined condition may indicate a relationship between a growth state of a specific part and at least one of a medium moisture content, an electrical conductivity, a hydrogen ion index, an ambient temperature of the specific part, humidity, an amount of light radiated to the specific part, or a carbon dioxide concentration.

The environmental control unit may control the environmental control equipment according to the predetermined condition, so as to adjust at least one of the medium moisture content, the electrical conductivity, the hydrogen ion index, the ambient temperature of the specific part, the humidity, the amount of light radiated to the specific part, or the carbon dioxide concentration.

The estimation unit may estimate, as the growth state of the plant, a type of a physiological disorder of the plant, and the environmental control unit may control the environmental control equipment according to a predetermined control content corresponding to the estimated type of the physiological disorder of the plant. The environmental control equipment may include air conditioning equipment which adjusts at least one of a temperature or humidity in the plant factory, air blowing equipment which controls at least one of a wind volume or a wind direction of wind supplied into the plant factory, a light source equipment which has a light source which radiates artificial light to the plant, and a nutrient solution supply equipment which adjusts a fertilizer concentration and supplies, to the plant, a nutrient solution with the fertilizer concentration adjusted. When the estimation unit estimates, as a physiological disorder of the plant, that tip burn is progressing, the environmental control unit may control the nutrient solution supply equipment so that a content of calcium contained in the nutrient solution increases, control the light source equipment in order to reduce an amount of light of the light source, control the air conditioning equipment in order to lower the temperature in the plant factory, or control the air blowing equipment to increase the wind volume of the wind supplied into the plant factory, in order to lower the temperature in the plant factory.

A growth state estimation method according to one aspect of the present invention may include acquiring a first image including a plant captured at a first time point and a second image including the plant captured at a second time point after the first time point. The growth state estimation method may include specifying a same specific part of the plant from each of the first image and the second image. The growth state estimation method may include estimating a growth state of the plant by comparing a state of the same specific part included in each of the first image and the second image.

A plant management method according to one aspect of the present invention may include acquiring a first image including a plant captured at a first time point and a second image including the plant captured at a second time point after the first time point. The plant management method may include specifying a same specific part of the plant from each of the first image and the second image. The plant management method may include estimating a growth state of the plant by comparing a state of the same specific part included in each of the first image and the second image. The plant management method may include controlling environmental control equipment which controls environment in a plant factory where the plant is cultivated, according to a predetermined condition corresponding to an estimation result of the growth state of the plant.

A program according to one aspect of the present invention may cause a computer to perform acquiring a first image including a plant captured at a first time point and a second image including the plant captured at a second time point after the first time point. The program may cause the computer to perform specifying a same specific part of the plant from each of the first image and the second image. The program may cause the computer to perform estimating a growth state of the plant by comparing a state of the same specific part included in each of the first image and the second image.

The summary clause does not necessarily describe all necessary features of the embodiments of the present invention. The present invention may also be a sub-combination of the features described above.

### BRIEF DESCRIPTION OF THE DRAWINGS

FIG. 1 is a diagram showing an example of a functional block of an overall configuration of a plant management system according to the present embodiment.

FIG. 2 is a diagram showing an example of a functional block of a plant management apparatus.

FIG. 3 is a diagram showing an example of change information showing a change in a growth state of a leaf in accordance with passage of time of the leaf.

FIG. 4A is an example of an image of the leaf including an impaired part imaged at a time point T1.

FIG. 4B is an example of an image of the leaf including the impaired part imaged at a time point T2.

FIG. 5 is a flowchart showing an example of a procedure of estimation of a growth state of a plant and environmental control corresponding to the growth state.

FIG. 6 is a diagram showing an example of a hardware configuration.

### DESCRIPTION OF EXEMPLARY EMBODIMENTS

Hereinafter, the present invention will be described through embodiments of the invention, but the following embodiments do not limit the invention according to claims. In addition, not all of the combinations of features described in the embodiments are essential to the solution of the invention.

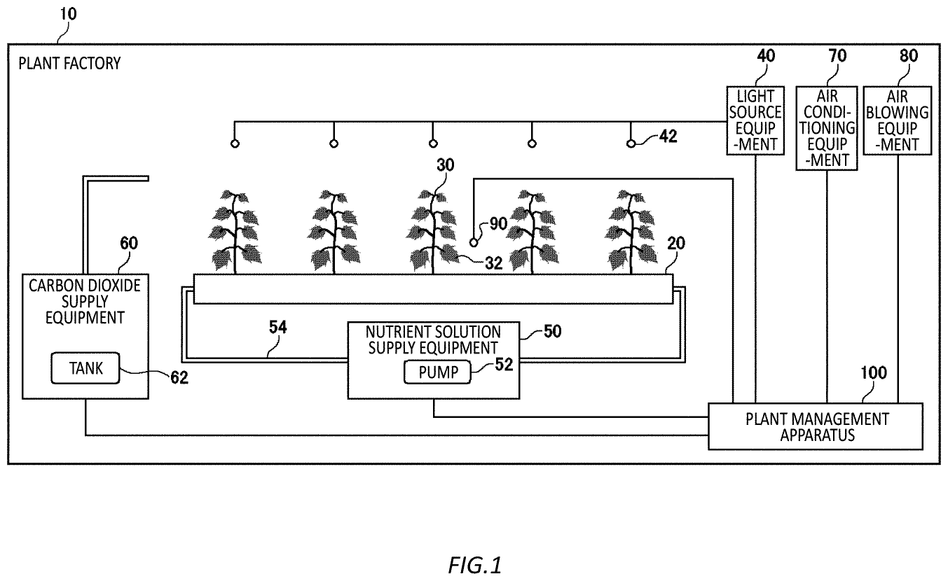

FIG. 1 is a diagram showing an example of a functional block of an overall configuration of a plant management system according to the present embodiment. The plant management system manages a growth state of a plant 30 that is cultivated in a plant factory 10. The plant management system includes a cultivation rack 20, light source equipment 40, nutrient solution supply equipment 50, carbon dioxide supply equipment 60, air conditioning equipment 70, air blowing equipment 80, an imaging apparatus 90, and a plant management apparatus 100. The light source equipment 40, the nutrient solution supply equipment 50, the carbon dioxide supply equipment 60, the air conditioning equipment 70, and the air blowing equipment 80 are examples of environmental control equipment.

The cultivation rack 20 cultivates the plant 30 such as a vegetable, a fruit, or a fresh flower. The light source equipment 40 includes a plurality of light sources 42 such as LEDs or incandescent lamps that radiate artificial light, and radiates the artificial light to the plant 30 from each of the plurality of light sources 42. The plurality of light sources 42 may be arranged to face a cultivation surface of the cultivation rack 20. The plant factory 10 in the present embodiment is an artificial light type plant factory. However, the plant factory 10 may be a solar light type plant factory where the plant 30 is cultivated by using solar light as a light source.

The nutrient solution supply equipment 50 has a pump 52 and a pipe 54, and supplies, to the cultivation rack 20 via the pump 52 and the pipe 54, a nutrient solution containing each of fertilizer components such as potassium or calcium. The nutrient solution supply equipment 50 appropriately adjusts a fertilizer concentration, and supplies, to the plant 30, the nutrient solution with the adjusted fertilizer concentration. The nutrient solution supply equipment 50 may supply the nutrient solution to the plant 30 by atomizing the nutrient solution with the adjusted fertilizer concentration and spraying the atomized nutrient solution onto a root part of the plant 30. The nutrient solution supply equipment 50 may function as irrigation equipment that supplies water to a medium in which the plant 30 is cultivated. An amount of irrigation that is supplied to the cultivation rack 20 may be adjusted by adjusting an amount of the nutrient solution that is supplied to the cultivation rack 20 from the nutrient solution supply equipment 50.

The carbon dioxide supply equipment 60 has a tank 62 and a nozzle 64. The tank 62 stores carbon dioxide. The carbon dioxide supply equipment 60 supplies carbon dioxide stored in the tank 62, into the plant factory 10 via the nozzle 64.

The air conditioning equipment 70 controls a temperature and humidity of an air in the plant factory 10, and circulates the air of which the temperature and the humidity are controlled, within an indoor space. The air blowing equipment 80 includes a circulator or a fan that supplies a wind into the plant factory 10.

The imaging apparatus 90 images a leaf 32 of the plant 30. The imaging apparatus 90 periodically images the leaf 32 of the plant 30 at predetermined intervals. The imaging apparatus 90 may be provided in the vicinity of each plant 30 cultivated on the cultivation rack 20. Alternatively, the imaging apparatus 90 may be provided in a mobile robot moving in the plant factory 10. The imaging apparatus 90 periodically images the leaf 32 of the plant 30 at the predetermined intervals in the same direction and at the same angle of view from the same position. Even in a case where the imaging apparatus 90 is provided on the mobile robot, the mobile robot controls the posture of the imaging apparatus 90 to periodically image the leaf 32 of the plant 30 at the predetermined intervals in the same direction and at the same angle of view from the same position. The mobile robot may be a mobile object such as a vehicle, a flying vehicle, or a ship. In the present embodiment, the description will be given about an example in which the imaging apparatus 90 images the leaf 32 of the plant 30, but the parts imaged by the imaging apparatus 90 may be other specific parts, such as a stem, a fruit, or a flower other than the leaf 32, of the plant 30.

The plant management apparatus 100 controls the growth state of the plant 30 by controlling the light source equipment 40, the nutrient solution supply equipment 50, the carbon dioxide supply equipment 60, the air conditioning equipment 70, and the air blowing equipment 80. The plant management apparatus 100 communicates with the light source equipment 40, the nutrient solution supply equipment 50, the carbon dioxide supply equipment 60, the air conditioning equipment 70, the air blowing equipment 80, and the imaging apparatus 90, via a wireless network or a wired network. The plant management apparatus 100 is an example of a growth state estimation apparatus.

The plant management apparatus 100 may be a computer having a central processing unit (CPU) and a memory. The light source equipment 40, the nutrient solution supply equipment 50, the carbon dioxide supply equipment 60, the air conditioning equipment 70, and the air blowing equipment 80 may include the computers having the central processing units (CPU) and the memories.

The computer may be a computer such as a personal computer, a tablet type computer, a smartphone, a workstation, a server computer, or a general purpose computer, or may be a computer system in which a plurality of computers are connected. Such a computer system is also a computer in a broad sense. The computer may be a dedicated computer designed for an environmental control of a plant factory, or may be dedicated hardware realized by dedicated circuitry. The computer may be implemented by a virtual computer environment. When the computer is used, the plant management apparatus 100, the light source equipment 40, the nutrient solution supply equipment 50, the carbon dioxide supply equipment 60, the air conditioning equipment 70, and the air blowing equipment 80 are realized by executing a program by the computer.

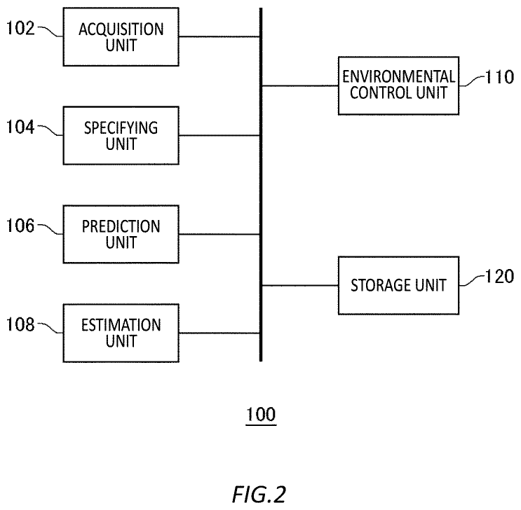

FIG. 2 is a diagram showing an example of a functional block of the plant management apparatus 100. The plant management apparatus 100 includes an acquisition unit 102, a specifying unit 104, a prediction unit 106, an estimation unit 108, an environmental control unit 110, and a storage unit 120.

The acquisition unit 102 periodically acquires images captured by the imaging apparatus 90 at predetermined intervals. The acquisition unit 102 acquires an image G1 including the plant 30 captured by the imaging apparatus 90 at a time point T1, and an image G2 including the plant 30 captured by the imaging apparatus 90 at a time point T2 after the time point T1. A period from the time point T1 to the time point T2 may be any period, such as one hour, one day, one week, or ten days, corresponding to the growth rate of the plant 30.

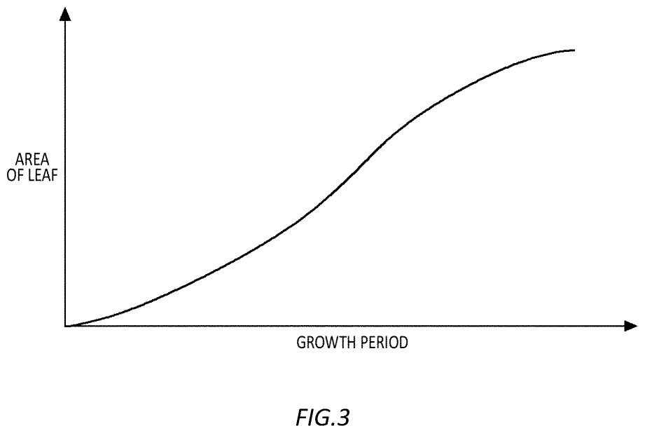

The specifying unit 104 specifies the same specific part of the plant 30 from each of the image G1 and the image G2. The specific part of the plant 30 may be a leaf, a stem, a fruit, or a flower. In the present embodiment, as the specific part, the leaf of the plant 30 are described in detail. That is, the specifying unit 104 specifies the same leaf 32 from each of the image G1 and the image G2. The prediction unit 106 predicts a change, which is a change with the passage of time from the time point T1 to the time point T2, in the growth state of the same leaf 32 included in the image G1 and the image G2, based on change information indicating a change in the growth state of the leaf with the passage of time of the leaf. For example, as shown in FIG. 3, the change information may be information indicating the area of the leaf corresponding to the growth period. The change information may be derived by measuring the area of the leaf for each growth period by experiments or the like in advance, and may be stored in the storage unit 120.

Based on the change information, the prediction unit 106 specifies the growth period T1 of the plant 30 at the time point G1 from an area S1 of the leaf 32 at the time point G1. Further, the prediction unit 106 predicts the area S2 of the leaf 32 when time has passed from the time point G1 to the time point G2, based on the change information. The prediction unit 106 provides a prediction result to the specifying unit 104. The specifying unit 104 specifies the same leaf 32 from each of the image G1 and the image G2, based on the prediction result. For example, the specifying unit 104 enlarges the leaf of the area S1 in the image G1 to generate an image of the leaf of the area S2, and performs pattern matching between the image and an image of at least one leaf in a predetermined region of the image G2, so as to specify the same leaf 32 from the image G2.

The predetermined region is a region in the image G2 corresponding to a predetermined size of region including the leaf 32 in the image G1. Alternatively, the specifying unit 104 derives the area of at least one leaf included within a predetermined region, which includes a position where the area S1 of the leaf exists in the image G1, in the image G2 and specifies the area S2 of the leaf from among the at least one leaf, so as to specify the same leaf 32.

The estimation unit 108 estimates the growth state of the plant 30 by comparing the state of the same leaf 32 included in each of the image G1 and the image G2. The estimation unit 108 estimates, as the growth state of the plant 30, whether the plant 30 is in a healthy state. The estimation unit 108 estimates, as the growth state of the plant 30, the state of the physiological disorder of the plant 30 or the impairment caused by diseases and pests.

The estimation unit 108 may compare the state of the same leaf 32 included in each of the image G1 and the image G2, so as to specify a transition in the size of the same leaf 32 and a transition in the size of the impaired part of the same leaf 32, and estimate, as the growth state of the plant, the progression degree of the impairment of the same leaf 32, based on the comparison of the transition in the size of the same leaf 32 and the transition in the size of the impaired part of the same leaf.

Based on a ratio of an increase rate in the size (area) of the same leaf 32 from the time point G1 to the time point G2 to an increase rate in the size (area) of the impaired part of the same leaf 32, the estimation unit 108 may estimate, as the growth state of the plant 30, the progression degree of the impairment of the same leaf 32.

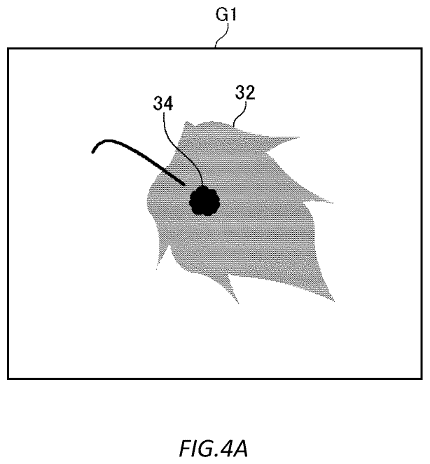

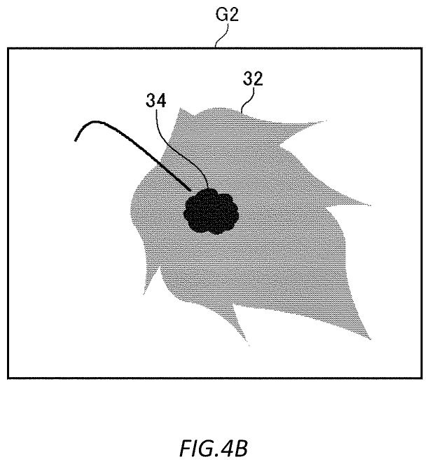

For example, the estimation unit 108 specifies the impaired part 34 from the leaf 32 in the image G1 of the time point T1 as shown in FIG. 4A, and derives the area S1 of the leaf 32 and the area S3 of the impaired part 34. Further, the estimation unit 108 specifies the impaired part 34 from the leaf 32 in the image G2 of the time point T2 as shown in FIG. 4B, and derives the area S2 of the leaf 32 and the area S4 of the impaired part 34. The estimation unit 108 derives a ratio R of an increase rate S4/S3 of the impaired part 34 to an increase rate S2/S1 of the leaf 32. The estimation unit 108 estimates the growth state of the plant 30 by specifying the progression degree of the impairment corresponding to the ratio R, based on relational information indicating a relationship between the ratio of the increase rate of the impaired part to the increase rate of the leaf and the progression degree of the impairment.

The environmental control unit 110 controls the environmental control equipment which controls the environment in the plant factory 10 where the plant 30 is cultivated, according to a predetermined condition corresponding to the estimation result of the growth state of the plant 30 by the estimation unit 108. According to the predetermined condition corresponding to the estimation result of the growth state of the plant 30 by the estimation unit 108, the environmental control unit 110 may control at least one of the light source equipment 40, the nutrient solution supply equipment 50, the carbon dioxide supply equipment 60, the air conditioning equipment 70, or the air blowing equipment 80.

The predetermined condition may indicate a relationship between the growth state of the leaf and at least one of a medium moisture content, an electrical conductivity, a hydrogen ion index, the ambient temperature of the leaf, humidity, the amount of light radiated to the leaf, or the carbon dioxide concentration. The environmental control unit 110 may control the environmental control equipment according to the predetermined condition, so as to adjust at least one of the medium moisture content, the electrical conductivity, the hydrogen ion index, the ambient temperature of the leaf, the humidity, the amount of light radiated to the leaf, or the carbon dioxide concentration. The environmental control unit 110 may control at least one of the light source equipment 40, the nutrient solution supply equipment 50, the carbon dioxide supply equipment 60, the air conditioning equipment 70, or the air blowing equipment 80 according to the predetermined condition, so as to adjust at least one of the medium moisture content, the electrical conductivity, the hydrogen ion index, the ambient temperature of the leaf, the humidity, the amount of light radiated to the leaf, or the carbon dioxide concentration.

A countermeasure to suppress the physiological disorder for each type of leaf physiological disorders are known empirically. In addition, the estimation unit 108 may estimate the type of a leaf physiological disorder occurring in the plant 30 by performing pattern matching between the image of each type of leaf physiological disorders stored in the storage unit 120 in advance and the image of the same leaf 32 included in the image G1 and the image G2. The storage unit 120 may stores, for each type of physiological disorders, the control contents of at least one of the light source equipment 40, the nutrient solution supply equipment 50, the carbon dioxide supply equipment 60, the air conditioning equipment 70, or the air blowing equipment 80. The environmental control unit 110 may specify the control contents corresponding to the estimated type of the physiological disorder of the leaf 32 by referring to the storage unit 120, and control, according to the specified control contents, at least one of the light source equipment 40, the nutrient solution supply equipment 50, the carbon dioxide supply equipment 60, the air conditioning equipment 70, or the air blowing equipment 80.

For example, when the tip burn due to calcium deficiency as the physiological disorder of the leaf 32 is progressing, the environmental control unit 110 may control the nutrient solution supply equipment 50 so as to increase the content of calcium contained in a nutrient solution. Alternatively, the environmental control unit 110 may control the light source equipment 40 in order to reduce the amount of light of the light source 42. The environmental control unit 110 may control the air conditioning equipment 70 in order to lower the temperature in the plant factory 10. In order to lower the temperature in the plant factory 10 efficiently, the environmental control unit 110 may control the air blowing equipment 80 to increase the wind volume of wind supplied into the plant factory 10.

The storage unit 120 stores a program which operates on the plant management apparatus 100. The program is executed on the processor included in the plant management apparatus 100, so as to cause the processor to function as the acquisition unit 102, the specifying unit 104, the prediction unit 106, the estimation unit 108, and the environmental control unit 110.

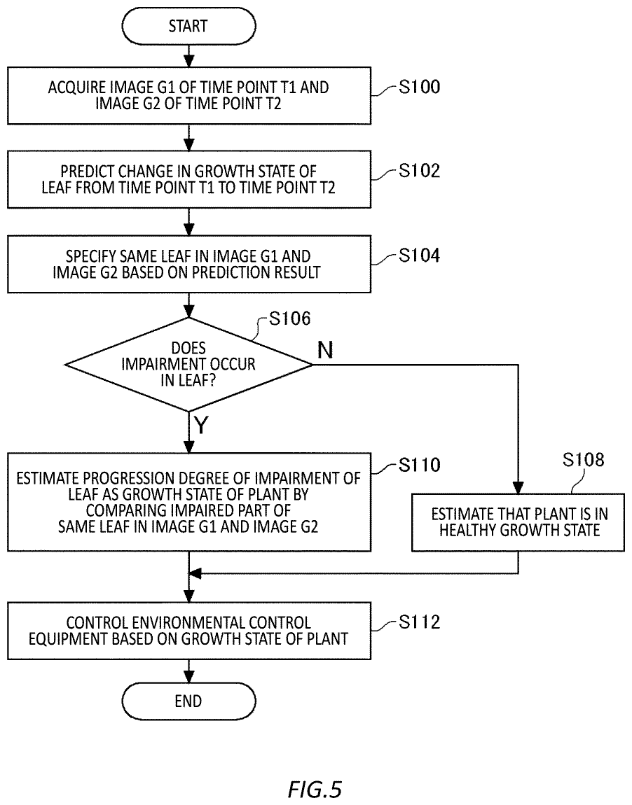

FIG. 5 is a flowchart showing an example of a procedure of the estimation of a growth state of the plant 30 and the environmental control corresponding to the growth state.

The acquisition unit 102 acquires the image G1 of the time point T1 and the image G2 of the time point T2 which are captured by the imaging apparatus 90 (S100). The prediction unit 106 predicts a change, which is a change with the passage of time from the time point T1 to the time point T2, in the growth state of the same leaf 32 included in the image G1 and the image G2, based on change information indicating a change in the growth state of the leaf with the passage of time of the leaf (S102).

The specifying unit 104 specifies the same leaf 32 from each of the image G1 and the image G2, based on the prediction result (S104). The estimation unit 108 determines whether impairment occurs in the leaf 32 by determining whether the leaf 32 in the image G1 and the image G2 includes the predetermined image portion corresponding to the impairment (S106). If it is determined that no impairment occurs in the leaf 32, the estimation unit 108 estimates that the plant 30 is in a healthy state (S108).

If it is determined that impairment occurs in the leaf 32, the estimation unit 108 compares the state of the same leaf 32 included in each of the image G1 and the image G2, so as to specify a transition in the size of the same leaf 32 and a transition in the size of the impaired part of the same leaf 32, and estimates, as the growth state of the plant 30, the progression degree of the impairment of the same leaf 32, based on the comparison of the transition in the size of the same leaf 32 and the transition in the size of the impaired part of the same leaf (S110).

Next, based on the estimation result by the estimation unit 108, the environmental control unit 110 controls at least one environmental control equipment of the light source equipment 40, the nutrient solution supply equipment 50, the carbon dioxide supply equipment 60, the air conditioning equipment 70, or the air blowing equipment 80, so as to cause the plant 30 to be in a predetermined growth state (S112).

According to the present embodiment above, it is possible to specify a specific part such as the same leaf of the plant 30 between images captured at different time points and to estimate the growth state of the plant, based on a change in the specific part such as the same leaf. Therefore, the burden of processing to estimate the growth state of plant can be reduced. In addition, when the imaging apparatus 90 is prepared, it is possible to estimate the growth state of the plant, for example, the progression degree of the physiological disorder of the plant or the impairment caused by diseases and pests and thus to perform environmental control more accurately, so that the growth state of the plant is improved at low cost.

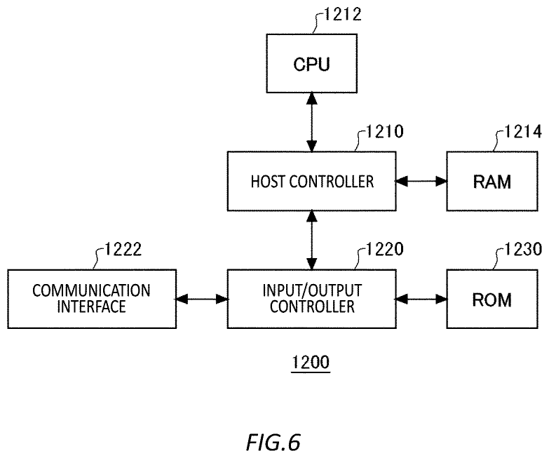

FIG. 6 shows an example of a computer 1200 in which an aspect of the present embodiment may be entirely or partially embodied. Programs installed in the computer 1200 can cause the computer 1200 to function as operations associated with the apparatus according to the embodiments of the present invention or one or more “units” of the apparatus. Alternatively, the programs can cause the computer 1200 to execute the operations or the one or more “units”. The programs can cause the computer 1200 to execute a process according to the embodiments of the present invention or steps of the process. Such programs may be executed by a CPU 1212 to cause the computer 1200 to perform specific operations associated with some or all of the blocks in the flowcharts and block diagrams described in the present specification.

The computer 1200 according to the present embodiment includes the CPU 1212 and a RAM 1214, which are mutually connected by a host controller 1210. The computer 1200 also includes a communication interface 1222 and an input/output unit, which are connected to the host controller 1210 via an input/output controller 1220. The computer 1200 also includes a ROM 1230. The CPU 1212 operates according to the programs stored in the ROM 1230 and the RAM 1214, thereby controlling each unit.

The communication interface 1222 communicates with other electronic devices via a network. A hard disk drive may store the programs and data used by the CPU 1212 in the computer 1200. The ROM 1230 stores therein boot programs or the like executed by the computer 1200 at the time of activation, and/or stores programs depending on hardware of the computer 1200. The programs are provided via a computer readable storage medium such as CR-ROM, a USB memory or an IC Card, or a network. The programs are installed on the RAM 1214, which also is an example of the computer readable storage medium, or the ROM 1230 and performed by the CPU 1212. Information processing written in these programs is read by the computer 1200, and provides cooperation between the programs and the various types of hardware resources described above. An apparatus or a method may be configured by implementing operations or processing of information according to a use of the computer 1200.

For example, in a case where a communication is performed between the computer 1200 and an external device, the CPU 1212 may execute a communication program loaded in the RAM 1214 and instruct the communication interface 1222 to perform communication processing based on a process written in the communication program. Under the control of the CPU 1212, the communication interface 1222 reads transmission data which is stored in the RAM 1214 or a transmission buffer region which is provided in a storage media such as a USB memory, to transmit the read transmission data to the network or write the reception data received from the network into a reception buffer region or the like provided on the storage media.

Also, the CPU 1212 may cause the whole or required part of files which are stored in the external storage media (such as USB memory) or the database to be read by the RAM 1214, to perform a various type of processes for the data on the RAM 1214. Then, the CPU 1212 may write back the processed data to the external storage media.

A various type of information such as a various type of programs, data, tables and databases may be stored in a storage media to undergo information processing. The CPU 1212 may execute, on the data read from the RAM 1214, various types of processing including various types of operations, information processing, conditional judgement, conditional branching, unconditional branching, information retrieval/replacement, or the like described throughout the present disclosure and specified by instruction sequences of the programs, to write the results back to the RAM 1214. Also, the CPU 1212 may retrieve information in the file, database, or the like in the storage media. For example, when a plurality of entries each having an attribute value of the first attribute associated with an attribute value of the second attribute are stored in a storage media, the CPU 1212 may retrieve, among the plurality of entries, an entry whose attribute value of the first attribute is specified and matches the conditions and read the attribute value of the second attribute stored in the entry, thereby acquiring the attribute value of the second attribute associated with the first attribute which satisfies a predetermined condition.

The programs or software module described above may be stored on the computer 1200 or in a computer readable storage medium near the computer 1200. In addition, a storage medium such as a hard disk or a RAM provided in a server system connected to a dedicated communication network or the Internet can be used as a computer readable storage media, thereby providing the program to the computer 1200 via the network.

A computer readable medium may include any tangible device that can store instructions to be executed by a suitable device. As a result, the computer readable medium having instructions stored therein includes an article of manufacture including instructions which can be executed to create means for performing operations specified in the flowcharts or block diagrams.

Examples of the computer readable medium may include an electronic storage medium, a magnetic storage medium, an optical storage medium, an electromagnetic storage medium, a semiconductor storage medium, and the like. Specific examples of the computer readable medium may include a floppy (Registered Trademark) disk, a diskette, a hard disk, a random access memory (RAM), a read-only memory (ROM), an erasable programmable read-only memory (EPROM or Flash memory), an electrically erasable programmable read-only memory (EEPROM (Registered Trademark)), a static random access memory (SRAM), a portable compact disc read-only memory (CD-ROM), a digital versatile disc (DVD), a Blu-ray (registered trademark) disc, a memory stick, an integrated circuit card, or the like.

The computer readable instructions may include either source code or object code written in any combination of one or more programming languages. The source code or the object code includes a conventional procedural programming language. The conventional procedural programming language may be assembler instructions, instruction-set-architecture (ISA) instructions, machine instructions, machine dependent instructions, microcode, firmware instructions, state-setting data, or an object oriented programming language such as Smalltalk (registered trademark), JAVA (registered trademark), C++, etc., and programming languages, such as the “C” programming language or similar programming languages. The computer readable instructions may be provided to a processor of a general purpose computer, special purpose computer, or other programmable data processing device, or to programmable circuitry, locally or via a local area network (LAN), a wide area network (WAN) such as the Internet, etc. The processor or the programmable circuitry may execute the computer readable instructions in order to create means for performing operations specified in the flowcharts or block diagrams. Examples of the processor include a computer processor, a processing unit, a microprocessor, a digital signal processor, a controller, a microcontroller, and the like.

While the present invention has been described by way of the embodiments, the technical scope of the present invention is not limited to the above described embodiments. It is apparent to persons skilled in the art that various alterations or improvements can be made to the above described embodiments. It is also apparent from the description of the claims that embodiments added with such alterations or improvements can be included in the technical scope of the present invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### DESCRIPTION OF REFERENCE NUMERALS

10: plant factory;
20 cultivation rack;
30: plant;
32: leaf;
34: impaired part
40: light source equipment;
42: light source;
50: nutrient solution supply equipment;
52: pump;
54: pipe;
60: carbon dioxide supply equipment;
62: tank;
64: nozzle;
70: air conditioning equipment;
80: air blowing equipment;
90: imaging apparatus
100: plant management apparatus;
102: acquisition unit;
104: specifying unit
106: prediction unit
108: estimation unit
110: environmental control unit;
120: storage unit;
1200: computer;
1210: host controller;
1212: CPU;
1214: RAM;
1220: input/output controller;
1222: communication interface;
1230: ROM.

1. A growth state estimation apparatus comprising a processor, wherein the processor:
acquires a first image including a plant captured at a first time point and a second image including the plant captured at a second time point after the first time point;
specifies a same specific part of the plant from each of the first image and the second image; and
estimates a growth state of the plant by comparing a state of the same specific part included in each of the first image and the second image.

2. The growth state estimation apparatus according to claim 1, wherein
the processor predicts a change, which is a change with passage of time from the first time point to the second time point, in a growth state of the same specific part, based on change information indicating a change in a growth state of a specific part of the plant in accordance with passage of time of the specific part of the plant, and
the processor specifies the same specific part from each of the first image and the second image, further based on a prediction result of the prediction unit.

3. The growth state estimation apparatus according to claim 2, wherein
the processor specifies a growth period of the plant at the first time point from an area of the specific part at the first time point, based on the change information, and predicts an area of the specific part of the plant when time has passed from the first time point to the second time point, based on the change information, and
the processor specifies, from the second image, a same specific part as the specific part included in the first image by enlarging an area of the specific part in the first image to be an area of the second time point based on the prediction result and performing pattern matching between the first image in which the specific part is enlarged and an image including at least one specific part in a predetermined region of the second image.

4. The growth state estimation apparatus according to claim 2, wherein
the processor specifies a growth period of the plant at the first time point from an area of the specific part at the first time point, based on the change information, and predicts an area of the specific part of the plant when time has passed from the first time point to the second time point, based on the change information, and
the processor derives, in the second image, an area of at least one specific part included in a predetermined region including a position where the specific part of the first image exists, and specifies, from among the at least one specific part, a specific part having the predicted area of the specific part at the second time point, so as to specify the same specific part.

5. The growth state estimation apparatus according to claim 1, wherein the processor estimates, as the growth state of the plant, a state of a physiological disorder of the plant or impairment caused by diseases and pests.

6. The growth state estimation apparatus according to claim 5, wherein the processor estimates a type of a physiological disorder of a specific part occurring in the plant by pattern matching an image for each type of physiological disorders of a predetermined specific part with an image of the same specific part included in the first image and the second image.

7. The growth state estimation apparatus according to claim 5, wherein the processor compares a state of the same specific part included in each of the first image and the second image, so as to specify a transition in a size of the same specific part and a transition in a size of an impaired part of the same specific part, and estimates, as the growth state of the plant, a progression degree of impairment of the same specific part, based on comparison of the transition in the size of the same specific part and the transition in the size of the impaired part of the same specific part.

8. The growth state estimation apparatus according to claim 7, wherein the processor estimates, as the growth state of the plant, the progression degree of the impairment of the same specific part, based on a ratio of an increase rate in the size of the same specific part to an increase rate in the size of the impaired part of the same specific part from the first time point to the second time point.

9. A plant management system comprising:
the growth state estimation apparatus according to claim 1; wherein
the processor controls environmental control equipment which controls environment in a plant factory where the plant is cultivated, according to a predetermined condition corresponding to an estimation result of the growth state of the plant.

10. The plant management system according to claim 9, wherein
the predetermined condition indicates a relationship between a growth state of a specific part and at least one of a medium moisture content, an electrical conductivity, a hydrogen ion index, an ambient temperature of the specific part, humidity, an amount of light radiated to the specific part, or a carbon dioxide concentration, and
the processor controls the environmental control equipment according to the predetermined condition, so as to adjust at least one of the medium moisture content, the electrical conductivity, the hydrogen ion index, the ambient temperature of the specific part, the humidity, the amount of light radiated to the specific part, or the carbon dioxide concentration.

11. The plant management system according to claim 9, wherein
the processor estimates, as the growth state of the plant, a type of a physiological disorder of the plant, and
the processor controls the environmental control equipment according to a predetermined control content corresponding to the type of the physiological disorder of the plant that is estimated.

12. The plant management system according to claim 11, wherein
the environmental control equipment includes air conditioning equipment which adjusts at least one of a temperature or humidity in the plant factory, air blowing equipment which controls at least one of a wind volume or a wind direction of wind supplied into the plant factory, a light source equipment which has a light source which radiates artificial light to the plant, and a nutrient solution supply equipment which adjusts a fertilizer concentration and supplies, to the plant, a nutrient solution with the fertilizer concentration adjusted, and
when the processor estimates, as the physiological disorder of the plant, that tip burn is progressing, the processor controls the nutrient solution supply equipment so that a content of calcium contained in the nutrient solution increases, controls the light source equipment in order to reduce an amount of light of the light source, controls the air conditioning equipment in order to lower the temperature in the plant factory, or controls the air blowing equipment to increase the wind volume of the wind supplied into the plant factory, in order to lower the temperature in the plant factory.

13. A growth state estimation method comprising:
acquiring a first image including a plant captured at a first time point and a second image including the plant captured at a second time point after the first time point;
specifying a same specific part of the plant from each of the first image and the second image; and
estimating a growth state of the plant by comparing a state of the same specific part included in each of the first image and the second image.

14. A plant management method comprising:
each step of the growth state estimation method according to claim 13; and
controlling environmental control equipment which controls environment in a plant factory where the plant is cultivated, according to a predetermined condition corresponding to an estimation result of the growth state of the plant.

15. A non-transitory computer readable medium having recorded thereon a program for causing a computer to perform:
when executed by the computer,
acquiring a first image including a plant captured at a first time point and a second image including the plant captured at a second time point after the first time point;
specifying a same specific part of the plant from each of the first image and the second image; and
estimating a growth state of the plant by comparing a state of the same specific part included in each of the first image and the second image.

16. The growth state estimation apparatus according to claim 2, wherein the processor estimates, as the growth state of the plant, a state of a physiological disorder of the plant or impairment caused by diseases and pests.

17. The growth state estimation apparatus according to claim 3, wherein the processor estimates, as the growth state of the plant, a state of a physiological disorder of the plant or impairment caused by diseases and pests.

18. The growth state estimation apparatus according to claim 4, wherein the processor estimates, as the growth state of the plant, a state of a physiological disorder of the plant or impairment caused by diseases and pests.

19. The growth state estimation apparatus according to claim 6, wherein the processor compares a state of the same specific part included in each of the first image and the second image, so as to specify a transition in a size of the same specific part and a transition in a size of an impaired part of the same specific part, and estimates, as the growth state of the plant, a progression degree of impairment of the same specific part, based on comparison of the transition in the size of the same specific part and the transition in the size of the impaired part of the same specific part.

20. The plant management system according to claim 10, wherein
the processor estimates, as the growth state of the plant, a type of a physiological disorder of the plant, and
the processor controls the environmental control equipment according to a predetermined control content corresponding to the type of the physiological disorder of the plant that is estimated.
